(19) United States
(12) Patent Application Publication
(10) Pub. No.: US 2010/0039965 A1
(43) Pub. Date: Feb. 18, 2010

(54) COMMUNICATIONS APPARATUS

(76) Inventor: Masazumi YAMAZAKI, Kanagawa (JP)

Correspondence Address: MCDERMOTT WILL & EMERY LLP, 600 13TH STREET, NW, WASHINGTON, DC, 20005-3096, US

(21) Appl. No.: 12/370,948

(22) Filed: Feb. 13, 2009

(30) Foreign Application Priority Data
Feb. 14, 2008 (JP) P2008-033271

(51) Int. Cl. H04B 15/00; H04B 7/00

(52) U.S. Cl. 370/277; 455/63.1

(57) ABSTRACT

The present invention provides a communication apparatus canceling a leakage component of the transmission frequency modulated signal superimposed on the input of the receiving circuit. The communication apparatus of the invention includes a transmitting circuit modulating a first baseband signal into a modulated signal by a first scheme, a receiving circuit demodulating a received input signal into a second baseband signal, an antenna duplexer guiding the modulated signal to an antenna and guiding a received signal received by the antenna to the receiving circuit, wherein the received input signal includes the received signal and a leak component of the modulated signal pass through the antenna duplexer, a cancel signal generating circuit generating a canceling signal which cancels the leak component, and a coupler combining the received input signal and the canceling signal, wherein an output signal of the coupler is demodulated at the receiving circuit.

### BACKGROUND OF THE INVENTION

The present invention relates a communications apparatus that constitutes at least a portion of a wireless communications system and that performs simultaneous transmission and reception and, more particularly, to a communications apparatus that cancels a transmission signal leaked into a received signal.

Various wireless communications schemes are used in wireless communication performed by a mobile communications terminal, such as a portable cellular phone. Of various wireless communications schemes, a W-CDMA scheme, for instance, uses different frequencies for a transmission frequency and a reception frequency, respectively, whereby wireless communication is performed by duplex transmission by means of which transmission and reception are simultaneously carried out.

FIG. 6 is a block diagram showing an example portable cellular phone terminal that performs communication by means of a wireless communications scheme which enables simultaneous transmission and reception. A portable cellar phone terminal AA1 shown in FIG. 6 has a transmission circuit AA2, a receiving circuit AA3, an antenna duplexer AA4, and an antenna AA5.

The transmission circuit AA2 modulates a transmission baseband signal output from an unillustrated baseband section and outputs a transmission signal. The transmission circuit AA2 has a modulator AA6, a bandpass filter AA7, a power amplifier AA8, and the like.

The receiving circuit AA3 demodulates a received signal input from the antenna duplexer AA4 and outputs a received baseband signal to an unillustrated baseband section. The receiving circuit AA3 has a low-noise amplifier AA9, a demodulator AA11, a channel selection filter AA12, and the like.

The antenna duplexer AA4 guides the transmission signal output from the transmission circuit AA2 to the antenna AA5 and guides the signal received by the antenna AA5 to the receiving circuit AA3. The antenna duplexer AA4 has a transmission filter AA13 that permits passage of a transmission signal but blocks passage of a received signal and a receiving filter AA14 that permits passage of a received signal but blocks passage of a transmission signal.

Operation of the portable cellular phone terminal AA1 is described below. The portable cellular phone terminal AA1 performs duplex transmission by means of which transmission operation and receiving operation are simultaneously carried out. First, transmission operation is described. The modulator AA6 modulates a transmission baseband signal output from an unillustrated baseband section and outputs a modulation signal of a transmission frequency. The bandpass filter AA7 suppresses noise of a receiving frequency band in the modulation signal of the transmission frequency output from the modulator AA6, and the power amplifier AA8 amplifies the transmission modulation signal and emits the thus-amplified signal from the antenna AA5 by way of the antenna duplexer AA4.

The modulation signal of the transmission frequency input to the antenna duplexer AA4 passes through the transmission filter AA13 and is guided to the antenna AA5. A portion of the signal is applied to the receiving filter AA14, as well. The transmission frequency signal is outside the pass band of the receiving filter AA14; hence, the signal does not pass through the receiving filter AA14.

Receiving operation is described below. A receiving frequency modulated signal received by the antenna AA5 is input to the antenna duplexer AA4. A modulation signal of a receive frequency input to the antenna duplexer AA4 passes through the receiving filter AA14 and is guided to the low noise amplifier AA9 of the receiving circuit AA3; and a portion of the modulated signal is applied to the transmission filter AA13, as well. However, the modulation signal of the receive frequency is outside the pass band of the transmission filter AA13 and hence does not pass through the transmission filter AA13.

The input receiving frequency modulation signal is amplified by the low-noise amplifier AA9 and demodulated into a received baseband signal by means of the demodulator AA11. Further, after the channel selection filter AA12 has eliminated adjacent channel signals from the demodulated baseband signal, the demodulated baseband signal is output to an unillustrated baseband section.

However, in the above-described portable cellular phone terminal AA1, when the transmission frequency and the reception frequency are close to each other, the amount of suppression on the transmission frequency imposed by the receiving filter AA14 becomes insufficient, whereupon a portion of the modulation signal of the transmission frequency leaks into the receiving circuit AA3. The modulation signal of the transmission frequency leaked into the receiving circuit AA3 turns into a disturbance wave for the modulation signal of the receive frequency, thereby saturating the low noise amplifier AA9 or the demodulator AA11, to thus induce gain suppression. As a consequence, a noise factor of the terminal serving as a receiver is deteriorated.

In this regard, according to JP-A-1-174018, JP-A-2003-273770, and the like, a leakage component of the modulation signal of the transmission frequency superimposed on the input of the receiving circuit is canceled by means of a signal generated by dividing a portion of the modulation signal of the transmission frequency and adjusting the amplitude and phase of the thus-divided portion. FIG. 7 is a block diagram showing a portable cellular phone terminal that is disclosed in JP-A-2003-273770 and that cancels a leakage component of a modulation signal of a transmission frequency. However, in the portable cellular phone terminal, a loss induced by a directional coupler 18 inserted in the transmission side increases, which results in an increase in power required by the transmission circuit 2.

In order to fulfill a requirement for recent high-speed data communication, the number of wireless communications schemes adopting a broadband modulation signal is increased. However, when the configurations described in JP-A-1-174018 and JP-A-2003-273770 are adopted for the wireless communications schemes, a frequency characteristic of the antenna duplexer cannot be disregarded, which decreases the effect of canceling the leakage component of the modulation signal of the transmission frequency.

In general, in order to achieve a superior suppression characteristic in a shield frequency band, a filter has an attenuation pole positioned in the shield frequency band. FIG. 8 is a view showing an example characteristic of the receiving filter AA14 belonging to the antenna duplexer AA4 of the portable cellular phone terminal shown in FIG. 6. As shown in FIG. 8, a transmission frequency band that is the shield frequency band has larger deviation in gain and group delay as compare to a receiving frequency band that is a passage frequency band of the receiving filter AA14. Hence, a waveform distortion of a leakage component of the modulation signal of the transmission frequency, which is a target to be cancelled, is superimposed on the original transmission frequency modulation signal. Therefore, no matter how the amplitude and phase of the canceling signal are controlled, the leakage component in the received signal cannot be fully canceled.

FIG. 9 is a view showing an example frequency characteristic of the receiving filter AA14 and a residual component achieved when a leakage component of a modulation signal of a transmission frequency having an ideal rectangular spectrum is canceled. Visibility of the drawing is deteriorated as a result of overlapping of loci of characteristics. For this reason, a leakage component of the modulation signal of the transmission frequency, a canceling signal, and a residual component are displayed with an offset. When a bandwidth of a modulated signal is narrow, a filter response (a gain and a group delay) achieved within a modulated signal band can be made close to a constant level. In relation to a signal having a modulated signal bandwidth BW shown in FIG. 9, a suppression amount of 19.3 dB is acquired as an effect of cancel of the leakage component when there is adopted the configuration of a portable cellular phone terminal that cancels the leakage component of the modulation signal of the transmission frequency.

The modulated signal bandwidth is increased by a factor of ten; namely, to 10BW. Deviation of the gain and the group delay, which are the cause of a decrease in the cancellation effect, generally increases as the bandwidth increases. In the embodiment shown in FIG. 9, even when the amplitude and phase of the canceling signal is optimally controlled, only a suppression amount of 3.8 dB is acquired as an effect of cancellation of a leakage component.

### SUMMARY OF THE INVENTION

The present invention aims at providing a communications apparatus that enables high-precision cancellation of a leakage component of a modulation signal of a transmission frequency superimposed on an input to a receiving circuit while avoiding an increase in a loss of a transmission circuit, in connection with a communications scheme by means of which at least a portion of a wireless communications system simultaneously performs transmission and reception.

The present invention provides a communications apparatus includes a transmitting circuit modulating a first baseband signal into a modulated signal by a first scheme, a receiving circuit demodulating a received input signal into a second baseband signal, an antenna duplexer guiding the modulated signal to an antenna and guiding a received signal received by the antenna to the receiving circuit. The received input signal includes the received signal and a leak component of the modulated signal pass through the antenna duplexer. The communications apparatus includes a cancel signal generating circuit generating a canceling signal which cancels the leak component, and a coupler combining the received input signal and the canceling signal, wherein an output signal of the coupler is demodulated at the receiving circuit.

The first and the second modulating scheme of the communications apparatus of the present invention can be a same modulating scheme.

As a first aspect of the communications apparatus of the invention, the cancel signal generating circuit includes a detecting circuit detecting a base band signal of the leak component from the second base band signal. The detecting circuit detects at least a phase and amplitude of the base band signal of the leak component. The cancel signal generating circuit includes a phase circuit control a phase of the first base band signal in reference to the phase of the base band signal of the leak component, a modulator modulating the first base band signal whose phase is controlled by the phase circuit by the first modulating scheme, and an amplifier controlling an amplitude of an output signal of the modulator in reference to the amplitude of the base band signal of the leak component. An output signal of the amplifier is the cancel signal.

In the communications apparatus, the detection circuit extracts the leakage component form the received signal converted into a zero IF by means of undersampling.

In the communications apparatus, the detection circuit has a filter for removing an extraneous disturbance signal that is in a band of the received signal.

As a second aspect of the communications apparatus of the present invention, the cancel signal generation circuit includes a detecting circuit dividing a band frequency of the second base band signal into a plurality of first bands, and detecting a phase and an amplitude of a signal of each of the first bands, a division part dividing a band frequency of the first base band signal into a plurality of second bands, a phase circuit controlling a phase of a signal of each of the second bands in reference to the phase of the signal of the first bands, a combining part combining an output of the phase circuit, a modulator modulating an output of the combining part by the first modulating scheme, an amplifier controlling an amplitude of an output of the modulator in reference to the amplitude of the signal of the first bands. An output of the amplifier is the cancel signal.

The communications apparatus of the present invention enables cancellation of the leakage component of the modulation signal of the transmission frequency superimposed on an input of the receiving circuit while avoiding an increase in a loss of the transmission circuit, and deterioration of a characteristic of the receiving circuit attributable to the leakage component can be avoided.

### BRIEF DESCRIPTION OF THE DRAWINGS

FIG. 1 is a block diagram showing a portable cellular phone terminal of a first embodiment;

FIG. 2 is a block diagram showing a first internal configuration of a detection circuit AE5 belonging to a cancel signal generation circuit AE3;

FIG. 3 is a block diagram showing a second internal configuration of a detection circuit AE5 belonging to a cancel signal generation circuit AE3;

FIG. 4 is a block diagram showing a third internal configuration of a detection circuit AE5 belonging to a cancel signal generation circuit AE3;

FIG. 5 is a block diagram showing a portable cellular phone terminal of a second embodiment;

FIG. 6 is a block diagram showing an example of portable cellular phone terminal that performs simultaneous transmission and reception;

FIG. 7 is a block diagram showing a portable cellular phone terminal that is described in JP-A-2003-273770 and that cancels a leakage component of a modulation signal of a transmission frequency;

FIG. 8 is a view showing an example characteristic of a receiving filter AA14 belonging to an antenna duplexer AA4 of the portable cellular phone terminal shown in FIG. 6; and

FIG. 9 is a view showing an example frequency characteristic of the receiving filter AA14 and residual components achieved when a leakage component of a modulation signal of a transmission frequency having an ideal rectangular spectrum is canceled.

### THE PREFERRED EMBODIMENT OF THE INVENTION

Embodiments of the present invention are described hereunder by reference to the drawings.

### First Embodiment

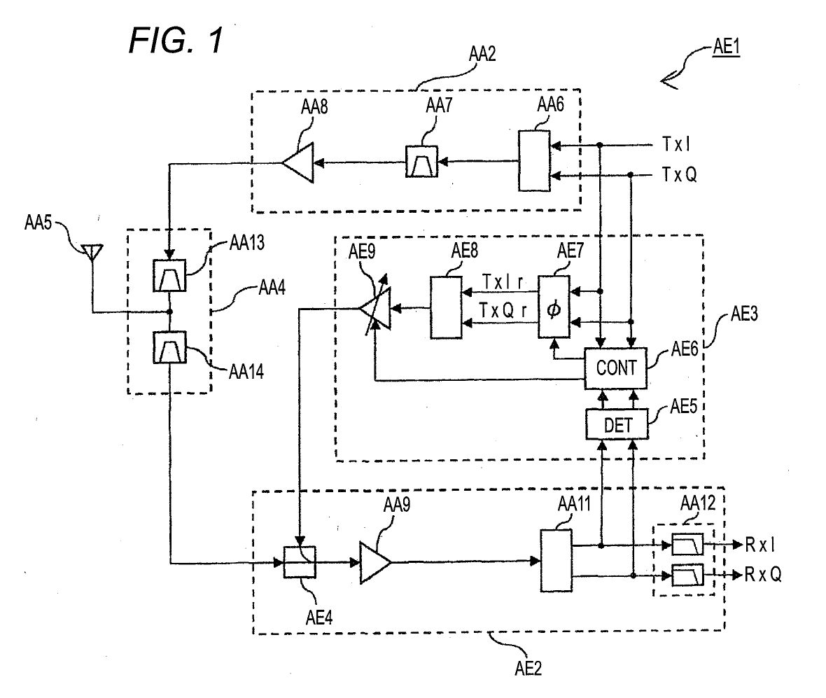

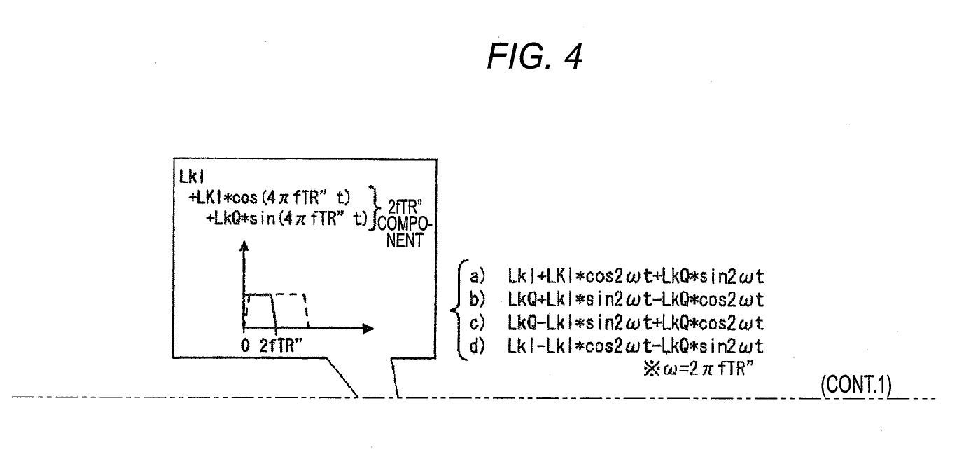

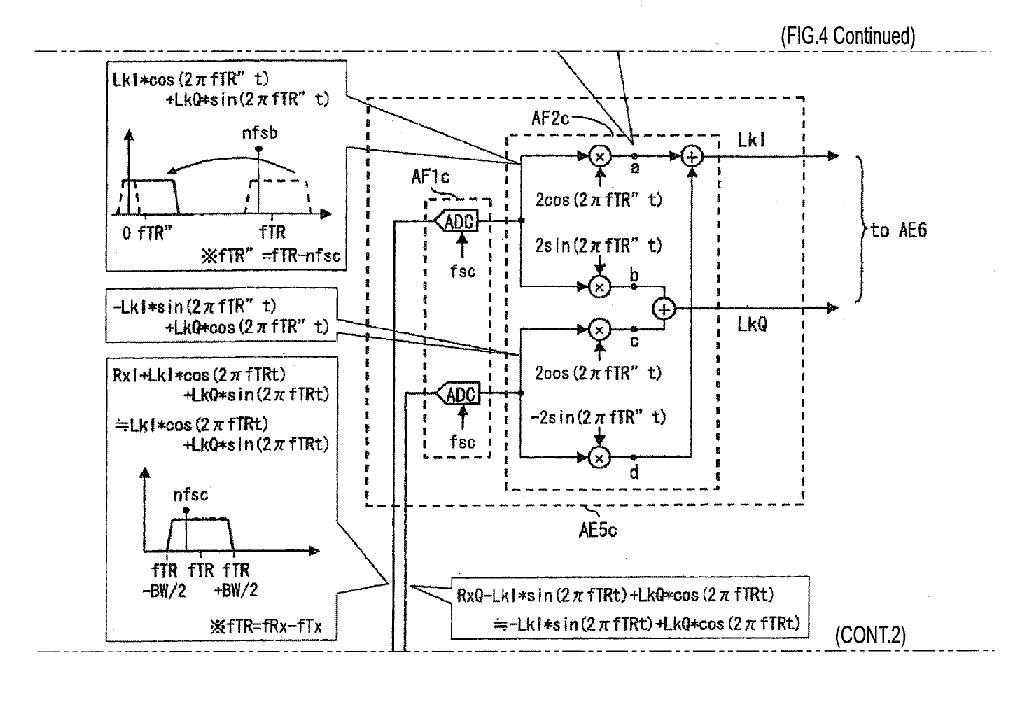

FIG. 1 is a block diagram showing a portable cellular phone terminal of a first embodiment. In FIG. 1, elements equivalent to the elements of the portable cellular phone terminal AA1 shown in FIG. 4 are assigned the same reference numerals. A portable cellular phone terminal AE1 shown in FIG. 1 has a transmission circuit AA2, a receiving circuit AE2, an antenna duplexer AA4, an antenna AA5, and a cancel signal generation circuit AE3.

The transmission circuit AA2 modulates a transmission baseband signal output from an unillustrated baseband section and outputs a transmission signal. The transmission circuit AA2 has a modulator AA6, a bandpass filter AA7, a power amplifier AA8, and the like.

The receiving circuit AE2 demodulates a received signal input from the antenna duplexer AA4 and outputs a received baseband signal to the unillustarate baseband section. The receiving circuit AE2 includes a coupler AE4, a low noise amplifier AA9, a demodulator AA11, and a channel selection filter AA12, and the like. Here, it is possible to change the back and forth order of the coupler AE4 and the low noise amplifier AA9.

The antenna duplexer AA4 guides the transmission signal output from the transmission circuit AA2 to the antenna AA5, as well as simultaneously guiding a signal received by the antenna AA5 to the receiving circuit AE2. The antenna duplexer AA4 has a transmission filter AA13 that permits passage of a transmission signal but blocks passage of a received signal and a receiving filter AA14 that permits passage of a received signal but blocks passage of a transmission signal.

The cancel signal generation circuit AE3 detects, from the signal received by the receiving circuit AE2, a leakage component stemming from the transmission circuit AA2 and generates a signal for canceling the leakage component. The cancel signal generation circuit AE3 has a detection circuit AE5, a control circuit AE6, a phase-shift circuit AE7, a modulator AE8, and a variable gain amplifier AE9. Respective constituent elements of the cancel signal generation circuit AE3 will be described later. A signal for canceling the leakage component generated by the cancel signal generation circuit AE3 is guided to a second input terminal of the coupler AE4 of the receiving circuit AE2.

Operation of the portable cellular phone terminal AE1 is described below. The portable cellular phone terminal AE1 performs duplex transmission by means of which transmission and receiving operations are simultaneously carried out. First, transmission operation is described. The modulator AA6 modulates a transmission baseband signal output from the unillustrated baseband section and outputs a modulation signal of a transmission frequency. Noise of a receiving frequency band in the modulation signal of the transmission frequency output from the modulator AA6 is suppressed by the bandpass filter AA7, and the signal is subsequently amplified by the power amplifier AA8. The thus-amplified signal is discharged from the antenna AA5 by way of the antenna duplexer AA4.

The modulation signal of the transmission frequency input to the antenna duplexer AA4 passes through the transmission filter AA13 and is guided to the antenna AA5. A portion of the signal is applied to the receiving filter AA14, as well. A portion of the modulation signal of the transmission frequency passes through the receiving filter AA4, to thus leak into the receiving circuit AE2.

Receiving operation is described below. The modulation signal of the receive frequency received by the antenna AA5 is input to the antenna duplexer AA4. The modulation signal of the receive frequency input to the antenna duplexer AA4 passes through the receiving filter AA14 and is guided to a first input terminal of the coupler AE4 of the receiving circuit AE2. A portion of the signal is applied to the transmission filter AA13, as well. However, the modulation signal of the receive frequency is outside the pass band of the transmission filter AA13; hence, the signal does not pass through the transmission filter AA13.

The coupler AE4 combines the modulation signal of the receive frequency and a leakage component of the modulation signal of the transmission frequency, both signals being applied to the first input terminal, with a signal applied to the second input terminal from the cancel signal generation circuit AE3, and outputs a resultant signal to the low noise amplifier AA9. For the sake of explanation, an output from the cancel signal generation circuit AE3 made immediately after initiation of transmission is assumed to be zero, and an output from the coupler AE4 is assumed to be only a component passed through the receiving filter AA14.

The signal output from the coupler AE4 is amplified by the low noise amplifier AA9, and the thus-amplified signal is demodulated into a receive baseband signal by the demodulator AA11. Further, the demodulated received baseband signal is output to the unillustrated baseband section after adjacent channel signals have been eliminated from the received baseband signal by the channel selection filter AA12.

In the present embodiment, the received baseband signal demodulated by the demodulator AA11 is also input to the detection circuit AE5 belonging to the cancel signal generation circuit AE3. The detection circuit AE5 detects the amplitude and phase of the leakage component of the modulation signal of the transmission frequency from the received baseband signal and outputs the thus-detected amplitude and phase to the control circuit AE6.

A modulation scheme for modulating the transmission baseband signal and a modulation scheme for modulating a signal received by the antenna AA5 may also be identical with each other or differ from each other.

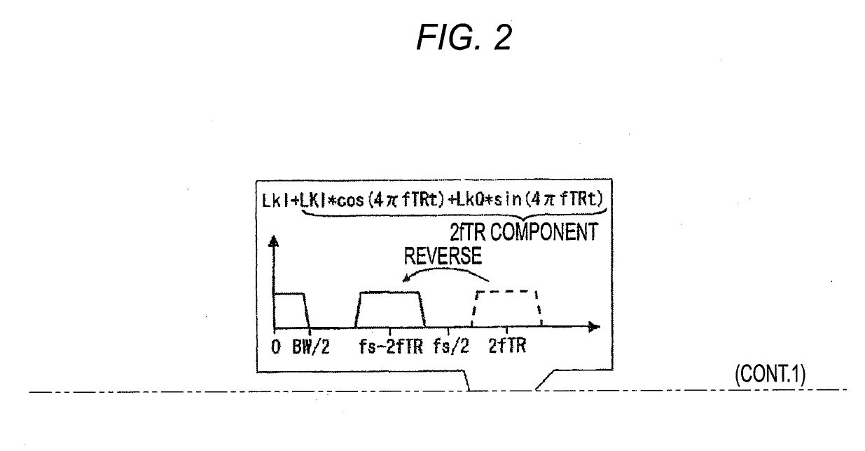

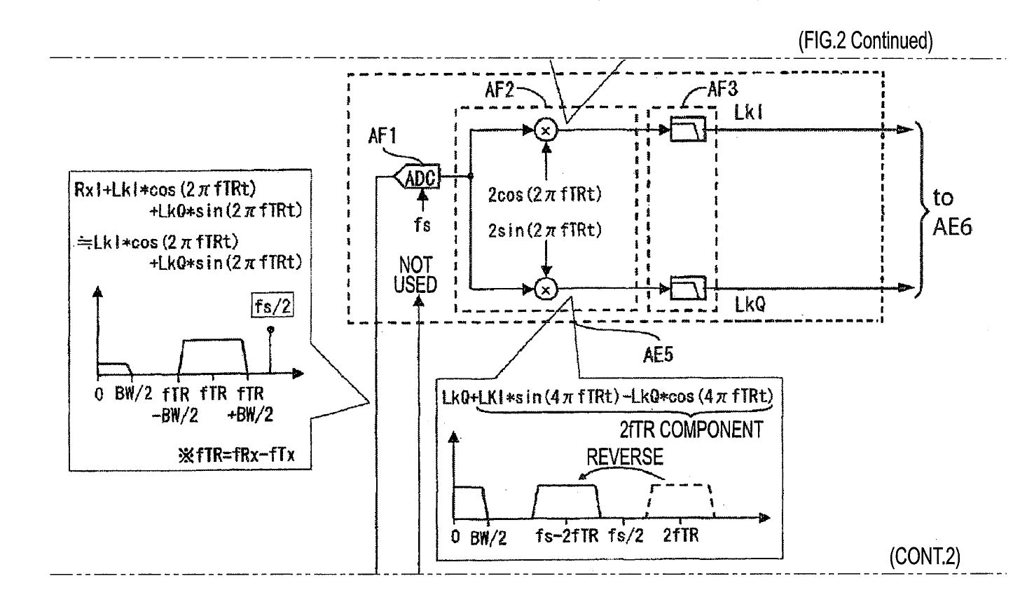

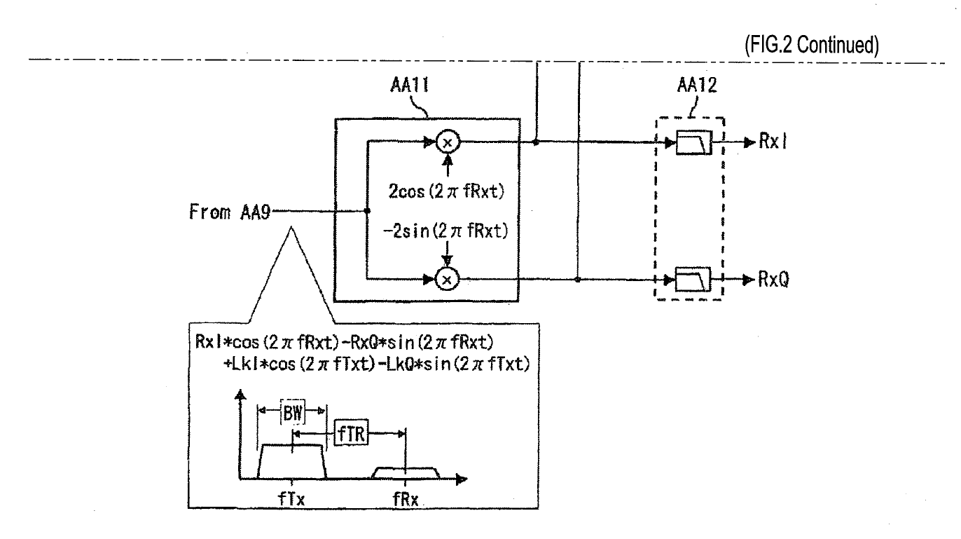

FIG. 2 is a block diagram showing the internal configuration of the detection circuit AE5 belonging to the cancel signal generation circuit AE3. As shown in FIG. 2, the detection circuit AE5 has an AD converter AF1, a demodulator AF2, a filter AF3, and the like.

The modulation signal of the receive frequency input to the demodulator AA11 of the receiving circuit AE2 is defined as R×1×cos (2πfRxt)−R×Q×sin (2πfRxt), and a leakage component of the modulation signal of the transmission frequency is defined as Lk1×cos (2πfTxt)−LkQ×sin (2×fTxt). “fRx” designates a receive frequency, and “fTx” designates a transmission frequency. Further, a relationship of fTx<fRx stands, and a bandwidth of the leakage component of the modulation signal of the transmission frequency is defined as BW.

Provided that the demodulator AA11 is a quadrature demodulator, an output from an in-phase part becomes, when a component (fTx+fRx) is disregarded, [Rx1×cos (2πfRxt)-RxQ×sin (2πfRxt)+Lk1×cos (2πfTxt)-LkQ×sin (2πfTxt)]×cos (2πfRxt)=Rx1+Lk1×cos (2πfTRt)+LkQ×sin (2πfTRt) . . . (1), where there stands fTR=fRx-fTx.

Concerning W-CDMA as an example, as 10×log {(LkÎ2+LkQ̂2)/(RxI ̂2+RxQ̂2)} is around 80 dB, RxI component is enough small to be ignored in the following discussion. But, since there is a case where a high field-strength disturbance wave is present in the vicinity of a received signal, an attempt may also be made to insert a filter to the input terminal of the AD converter AF1 of the detection circuit AE5, to thus lessen the influence of the disturbance wave.

Besides, as the output of the in-phase includes the in-phase component and the orthogonal component of the leakage component of the transmission frequency, the orthogonal side out put of the demodulator AA11 is not used.

Here, put fs as a sample frequency of AD converter AF1 of the detection circuit AE5 included by the cancel signal generation circuit AE3. By selecting fs satisfying fs/2>frR+BW/2, it is possible to prevent superposition of aliaising noises and extract the disturbance wave component due to the leak signal of transmission frequency.

In the meantime, receiving sensitivity to be fulfilled at the maximum transmission power of the portable cellular phone terminal AE1 varies according to a frequency band. However, the level of a received signal at Band “1” (a 2-GHz band) is −106.7 dB, and the leakage component of the modulation signal of the transmission frequency is greater than the received signal by 80 dB or more. Therefore, a term of Rx1 of the output from the AD converter AF1 expressed by Equation (1) can be disregarded. Since there is a case where a high field-strength disturbance wave is present in the vicinity of a received signal, an attempt may also be made to insert a filter to the input terminal of the AD converter AF1 of the detection circuit AE5, to thus lessen the influence of the disturbance wave. By means of such a configuration, the detection circuit AE5 can perform all of processing operations subsequent to processing pertaining to the AD converter AF1, by means of digital processing, and miniaturization of the circuit can be realized.

The output of the AD converter AF1 is demodulated by the demodulator AF2 and transformed into the baseband signals of the leakage component of transmission frequency LkI and LkQ by removing the reverse component of frequency 2fTR with the filter AF3, and then output to the control circuit AE6.

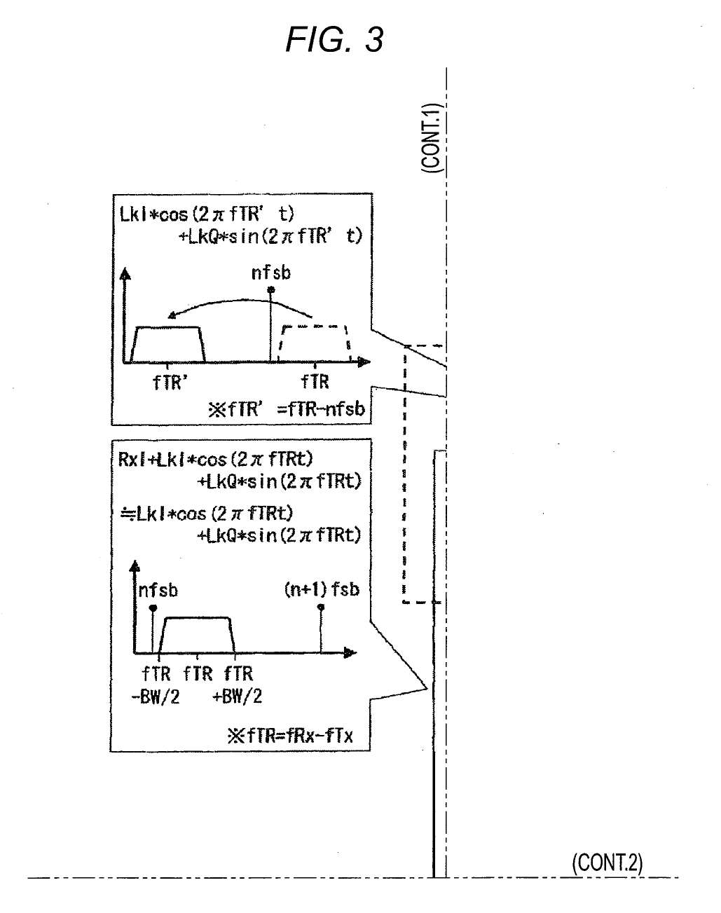

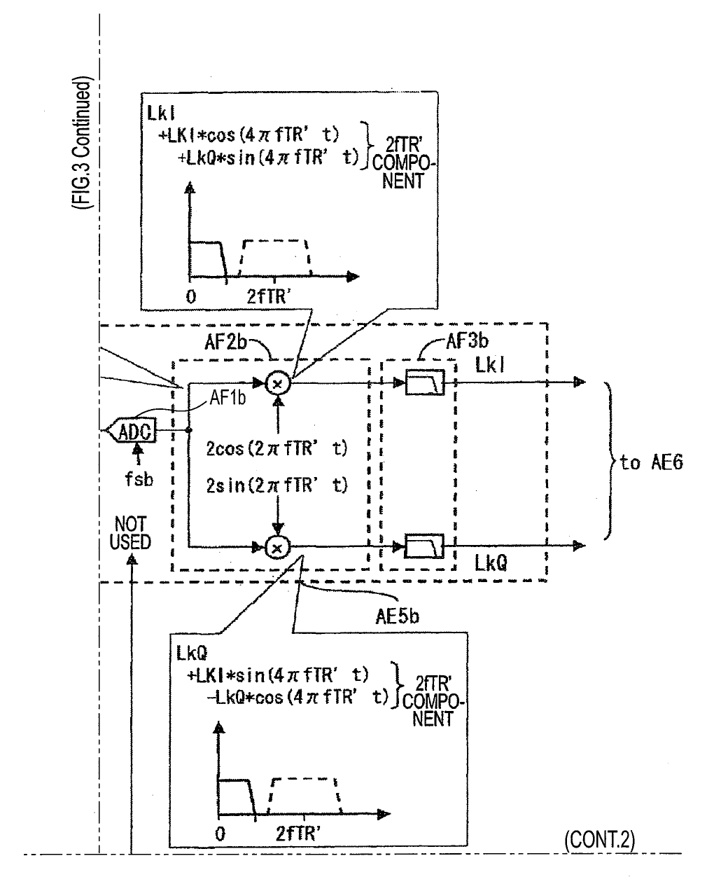

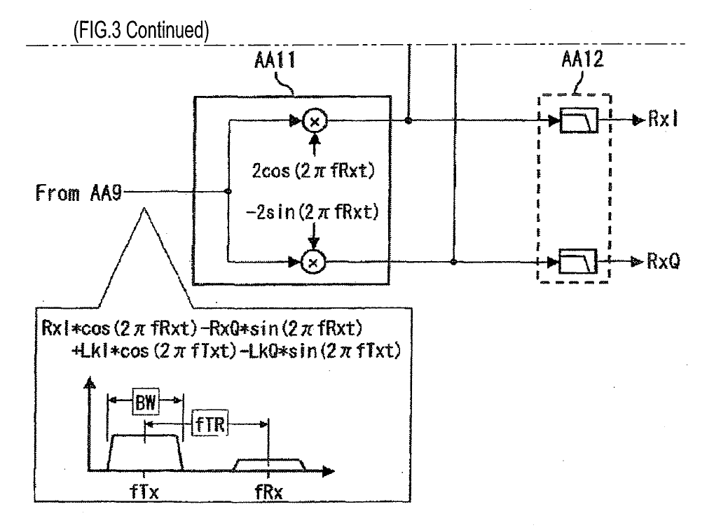

FIG. 3 is a block diagram showing a second internal configuration of the detection circuit AE5 belonging to the cancel signal generation circuit AE3. The corresponding part to that of FIG .2 is numbered same as in FIG. 2. As shown in FIG. 3, the detection circuit AE5b includes an AD converter AF1b, a demodulator AF2b, and a filter AF3b, and like that.

A sampling frequency of the AD converter AF1b in the detection circuit AE5b belonging to the cancel signal generation circuit AE3 is labeled as fsb, and fsb for which there is an integer “n” satisfying BW/2<fTR-nfsb<fsb-BW/2 is selected, whereby an output from the AD converter AF1b becomes equivalent to Lk1×cos (2πfTR′t)+LkQ×sin (2πfTR′t) by means of an undersampling effect. Here, fTR′=fTR-nfsb

At this stage, in order to sample the modulated signal in band width BW with avoiding the effect of the aliasing noise, the condition fsb>2BW is required. As compare to the configuration illustrated in FIG. 2, however, the sample frequency of the AD converter can be lowered, low energy consumption of the circuit can be achieved.

FIG. 4 is a block diagram showing a third internal configuration of a detection circuit AE5 belonging to the cancel signal generation circuit AE3. The corresponding part to that of FIG. 2 is numbered same as in FIG. 2. As shown in FIG. 4, the detection circuit AE5c includes an AD converter AF1c, a demodulator AF2c, and like that.

A sampling frequency of the AD converter AF1c in the detection circuit AE5c belonging to the cancel signal generation circuit AE3 is labeled as fsc. When such an integer n that satisfies BW/2>fTR-nfsc or fTR-nfsc<fsc-BW/2 exists, the result of multiplication of the in-phase side output from the AD converter AF1c and 2 cos (2 π fTR″t) is Lk1+LkI×cos (4πfTR″t)+LkQ×sin(4πfTR″t) . . . (a). In this output, as the first term (baseband component) and the second term and the third term (2fTR″ component) are superimposed, they are not able to be separated by a filter as shown in FIG. 2 and FIG. 3. Here fTR″=fTR-nfsc.

At this stage, by summing up above multiplication result (a) and the multiplication result of −2 sin (2 π fTR″t) and the orthogonal side sample output of the AD converter AF1c, 2fTR″ component are removed and thus the baseband component LkI can be obtained. Similarly, by summing up the multiplication result (b) of the in-phase side sample output of the AD converter AF1c and 2 sin (2 π fTR″t), and the multiplication result (c) of the orthogonal side sample output of the AD converter AF1c and 2 cos (2 π fTR″t), 2fTR″ component are removed and thus the baseband component LkQ can be obtained. In FIG. 4, the explicit mathematical descriptions of each signal (a) to (d) are indicated.

By adopting above mentioned configurations, the plurality of bands differing in fTR can be dealt with without fs change.

On the basis of the phase of the transmission baseband signal and the phase of the baseband signal of the leakage component of the modulation signal of the transmission frequency detected by the detection circuit AE5, the control circuit AE6 outputs a phase information φ so that the difference between the phase of the leakage component of the modulation signal of the transmission frequency passed through the receiving filter AA14 and the phase of the canceling signal output from the cancel signal generation circuit AE3 comes to 180° at the output of the coupler AE4.

The phase-shift circuit AE7 rotates the input transmission baseband signal through an angle φ and outputs the signal to the modulator AE8. Provided that the transmission baseband signal is taken as Tx1 and TxQ and that an output from the phase-shift circuit AE7 is taken as Tx1r and TxQr, the following relationships stand between the signals:

Tx1r=Tx1×cosφ−TxQ×sinφ (2)

TxQr=Tx1×sinφ+TxQ×cosφ (3).

Phase-shift processing pertaining to the phase-shift circuit AE7 is performed through computation processing in a baseband area. However, phase-shift processing may also be realized by means of processing that is described in connection with JP-A-1-174018 and that may be realized by a variable phase-shifter in a radio frequency region.

The modulator AE8 modulates an output from the phase-shift circuit AE7. The modulated signal output from the modulator AE8 is applied to the second input terminal of the coupler AE4 after having been amplified by the variable gain amplifier AE9.

On the basis of the amplitude of the transmission baseband signal and the amplitude of a baseband signal of a leakage component of the modulation signal of the transmission frequency detected by the detection circuit AE5, the control circuit AE6 outputs a gain control information that makes the amplitude of the leakage component of the modulation signal of the transmission frequency passed through the receiving filter AA14 equal to the amplitude of a canceling signal output from the cancel signal generation circuit AE3 at the output of the coupler AE4. The variable gain amplifier AE9 amplifies a modulation signal output from the modulator AE8 on the basis of the gain control information input from the control circuit AE6.

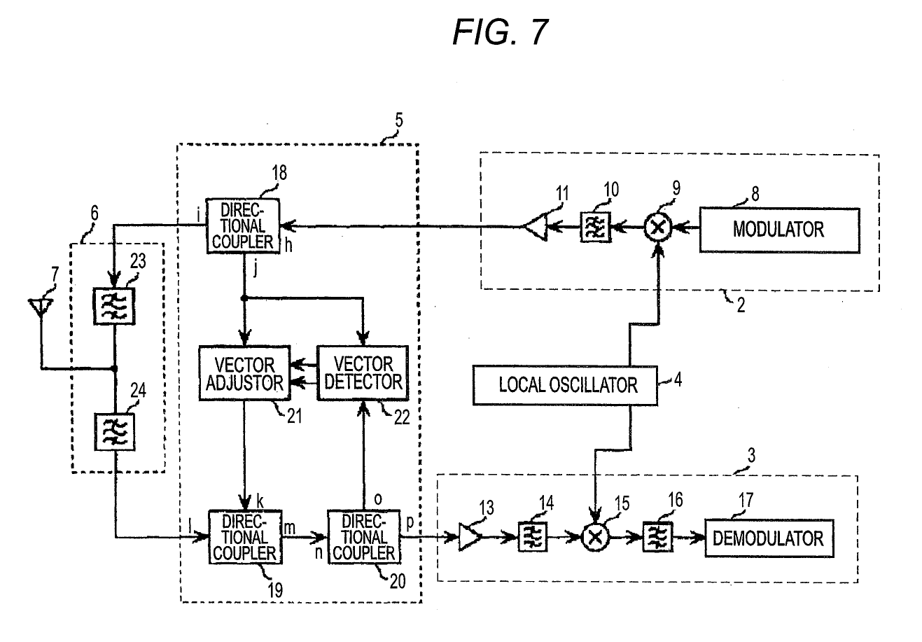

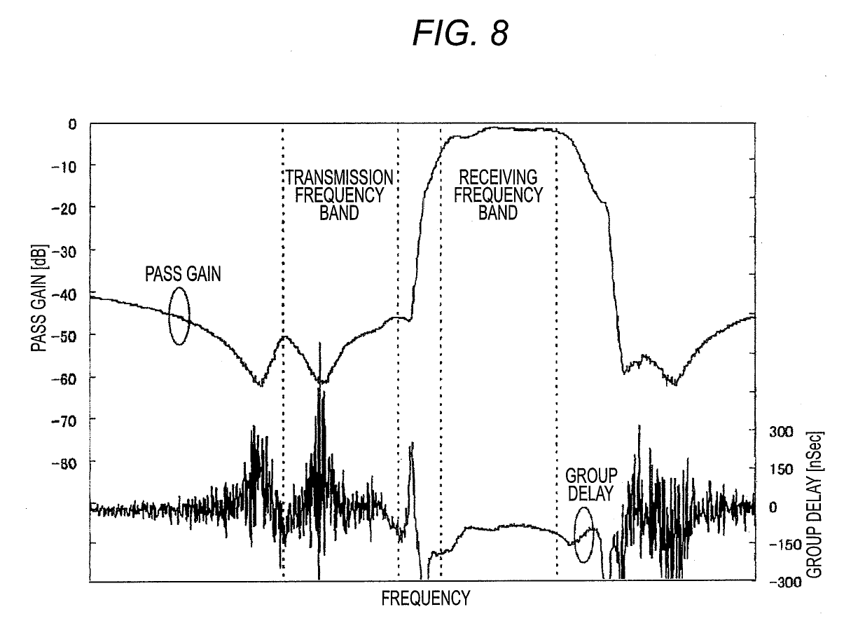

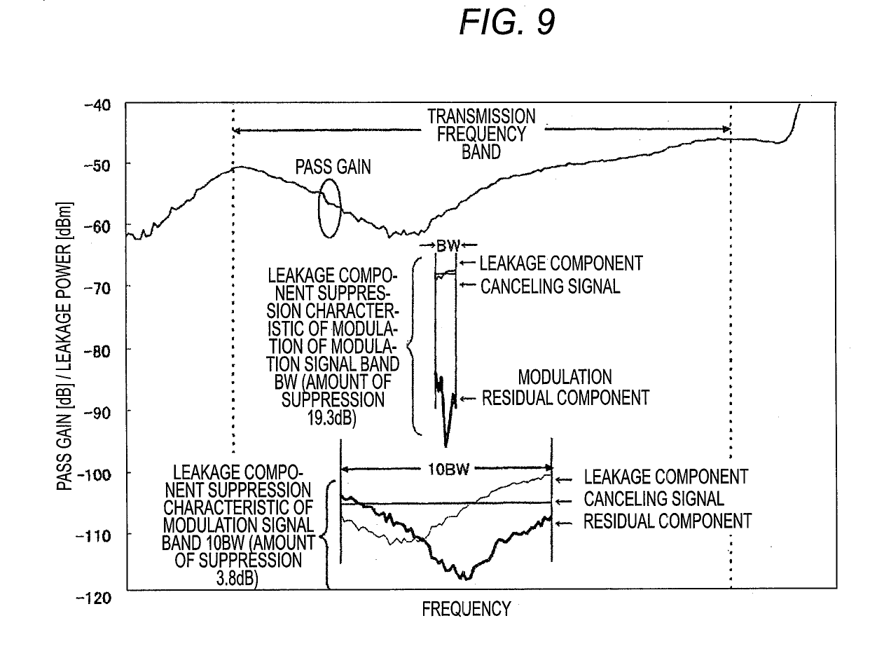

As described above, the portable cellular phone terminal of the present embodiment cancels the leakage component of the modulation signal of the transmission frequency superimposed on the signal input to the receiving circuit AE2 by the antenna duplexer AA4; hence, deterioration of a characteristic of the receiving circuit attributable to the leakage component can be avoided. Further, as comparing to the portable cellular phone terminal that cancels the leakage component of the modulation signal of the transmission frequency shown in FIG. 7, the portable cellular phone terminal of the present embodiment does not need a directional coupler on the transmission side. Therefore, an increase in power required by the transmission circuit can be avoided. Consequently, power consumption can be reduced.

### Second Embodiment

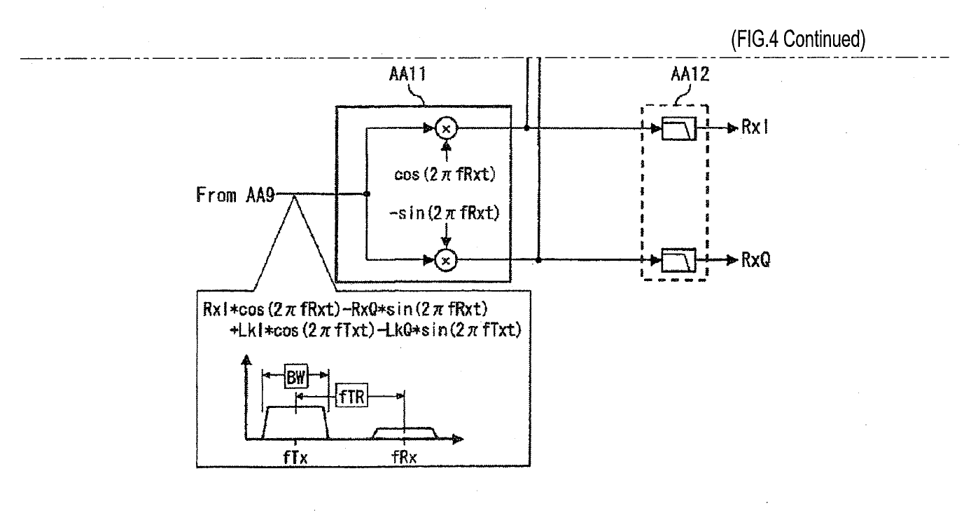

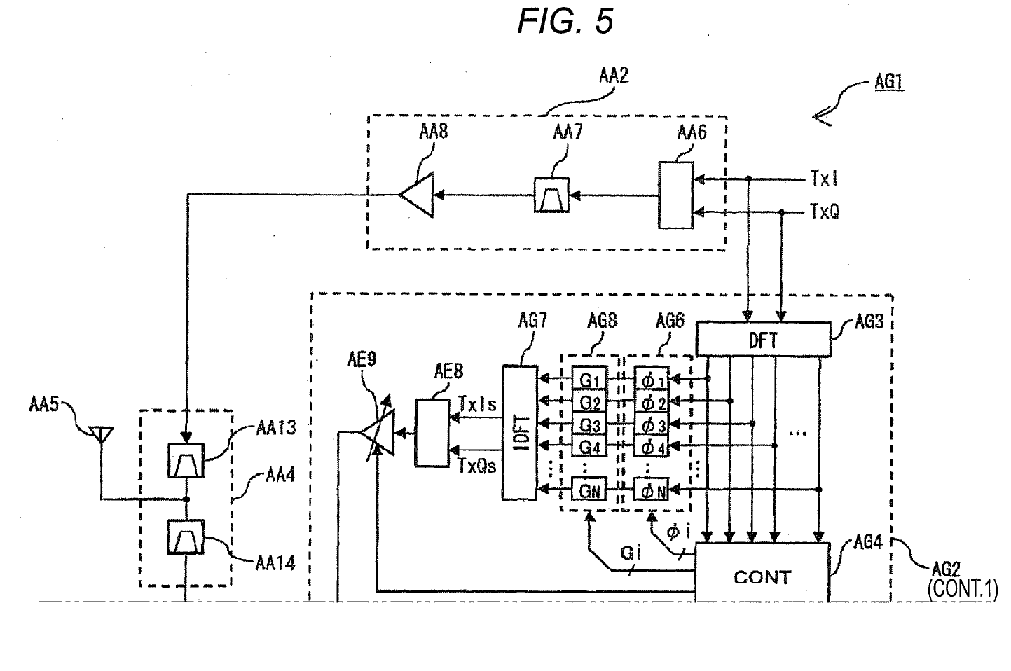

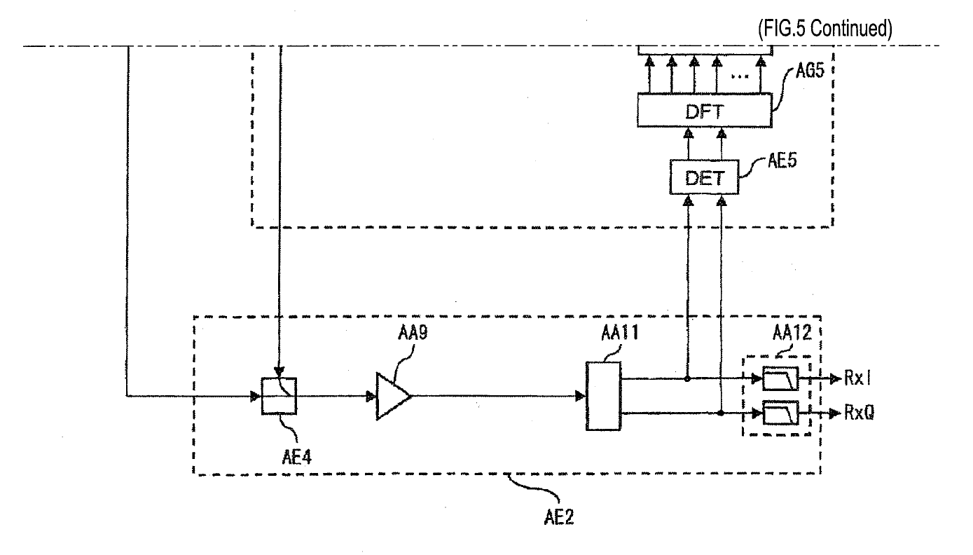

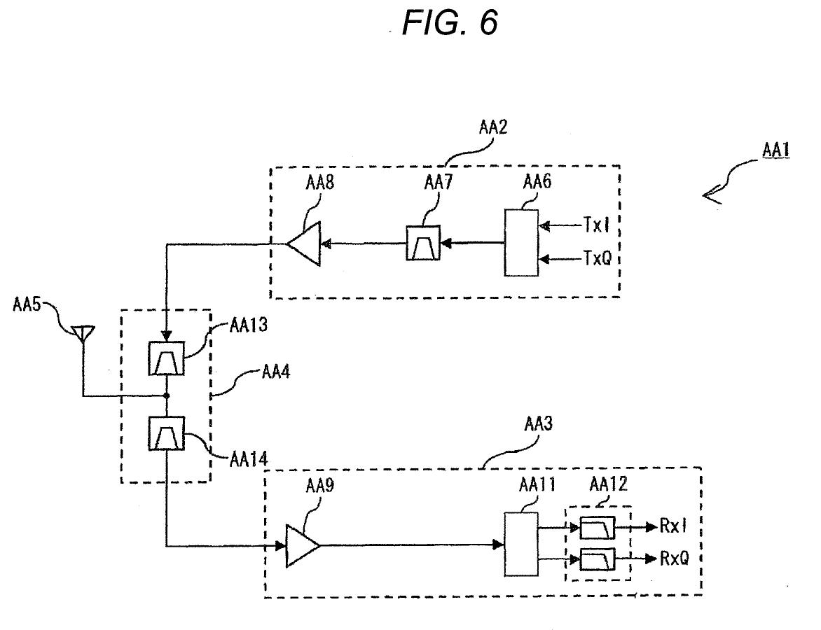

FIG. 5 is a block diagram showing a portable cellular phone terminal of a second embodiment. In FIG. 5, elements corresponding to the elements of the portable cellular phone terminal AE1 shown in FIG. 1 are assigned the same reference numerals. A portable cellular phone terminal AG1 shown in FIG. 5 has the transmission circuit AA2, the receiving circuit AE2, the antenna duplexer AA4, the antenna AA5, and a cancel signal generation circuit AG2. Since the transmission circuit AA2, the receiving circuit AE2, the antenna duplexer AA4, and the antenna AA5 are analogous to those described in connection with the first embodiment, and hence their explanations are omitted.

The cancel signal generation circuit AG2 has a discrete Fourier transform (DFT) circuit AG3, a detection circuit AE5, a control circuit AG4, DFT circuit AG5, a phase circuit AG6, a variable gain circuit AG8, an inverse discrete Fourier transform (IDFT) AG7, a modulator AE8, and a variable gain amplifier AE9. Since the detection circuit AE5, the modulator AE8 and the variable gain amplifier AE9 are analogous to those described in connection with the first embodiment, and hence their explanations are omitted.

The detection circuit AE5 detects the leak component of the modulated signal of the transmission frequency LkI and LkQ and applies them to the DFT circuit AG5 by the operation analogous to the first embodiment. The leak component of the modulation signal of the transmission frequency converted into Ns discrete spectrum by the DFT circuit AG5 are compared to the transmission baseband signal similarly converted into Ns discrete spectrum by the DFT circuit AG3 in phase and amplitude of each frequency component.

On the basis of the outputs from the DFT circuit AG3 and the DFT circuit AG5, the control circuit AG4 output a phase information Φ i (i=1˜N) to the phase circuit AG6 so that the phase difference between the leak component of the modulation signal of the transmission frequency passed through the receiving filter AA14 and the cancel signal output from the cancel signal generation circuit AE3 are 180° at the output of the coupler AE4 in each frequency.

On the basis of the outputs from the DFT circuit AG3 and the DFT circuit AG5, the control circuit AG4 output a phase information Gi (i=1˜N) to the variable gain circuit AG8 so that the amplitude difference between the leak component of the modulation signal of the transmission frequency passed through the receiving filter AA14 and the cancel signal output from the cancel signal generation circuit AE3 are 180° at the output of the coupler AE4 in each frequency.

The control circuit AG4 output the amplitude difference Gi(i=1˜N) between the amplitude of the leak component of the transmission frequency passed through the receiving filter AA14 and the amplitude of the cancel signal output from the cancel signal generation circuit AE3 to the gain

The phase circuit AG6 rotates the phase of the transmission baseband signal by Φ i in each frequency component and output them to the variable gain circuit AG8.

The variable gain circuit AG8 changes the output from the output signal AG8 by gain Gi in each frequency component so as to control the amplitude ratio in each frequency component to be equal to the amplitude ratio of the leak component of the modulation signal of the transmission frequency.

The output from the variable gain circuit AG8 are applied to the IDFT circuit AG7.

The IDFT circuit AG7 converts the discrete spectrum output from the variable gain circuit AG8 into the time signal TxIs and TxQs, and then these signals are converted in to the cancel signal by the modulator AE8 and the variable gain amplifier AE9.

The gain of the variable gain amplifier AE9 are set such a value that the amplitude of the leak component of the modulation signal of the transmission frequency passed through the receiving filter AA14 are equal to the amplitude of the cancel signal output from the cancel signal generation circuit AE3.

In a transmission apparatus adopting a multi career type modulation scheme such as OFDM and SC-FDMA, the DFT circuit AG3, AG5 and the IDFT circuit AG7 are set to be a shared use with the modulation/demodulation circuit or configured to be an integrated configuration, and thererby the benefit such as the size reduction of the circuit and the man-hour reduction of circuit designing are achieved.

As explained above, according to the portable cellar phone of the present embodiment, it is possible to control the phase in each finely discrete band of band width. Therefore, the leak component of the modulation signal of the transmission frequency can be more precisely canceled.

The communication apparatus according to the present invention is useful for a communication apparatus which performs simultaneous transmission and reception in at least a part of a wireless communication system. Especially, the application to a data communication scheme such as LTE, OFDM transmission circuit, and MIMO can be considered.

What is claimed is:

1. A communication apparatus comprising
a transmitting circuit modulating a first baseband signal into a modulated signal by a first scheme;
a receiving circuit demodulating a received input signal into a second baseband signal;
an antenna duplexer guiding the modulated signal to an antenna and guiding a received signal received by the antenna to the receiving circuit, wherein the received input signal includes the received signal and a leak component of the modulated signal pass through the antenna duplexer;
a cancel signal generating circuit generating a canceling signal which cancels the leak component; and
a coupler combining the received input signal and the canceling signal, wherein an output signal of the coupler is demodulated at the receiving circuit.

2. The communications apparatus according to claim 1, wherein the first and the second modulating scheme is a same scheme.

3. The communications apparatus according to claims, wherein the cancel signal generating circuit comprising:
a detecting circuit detecting a base band signal of the leak component from the second base band signal wherein at least a phase and amplitude of the base band signal of the leak component is detected;
a phase circuit control a phase of the first base band signal in reference to the phase of the base band signal of the leak component;
a modulator modulating the first base band signal whose phase is controlled by the phase circuit by the first modulating scheme; and
an amplifier controlling an amplitude of an output signal of the modulator in reference to the amplitude of the base band signal of the leak component; wherein an output signal of the amplifier is the cancel signal.

4. The communications apparatus according to claim 3, wherein the detecting circuit extracts the leak component from a received signal modulated into zero-IF by undersample.

5. The communications apparatus according to claim 4, wherein the detecting circuit has a filter which removes an extrinsic noise in the band width of the received signal.

6. The communications apparatus according to claim 3, wherein the detecting circuit has a filter which removes an extrinsic noise in the frequency band of the received signal.

7. The communications apparatus according to claim 1, wherein the cancel signal generating apparatus comprises:
a detecting circuit dividing a band frequency of the second base band signal into a plurality of first bands, and detecting a phase and an amplitude of a signal of each of the first bands;
a division part dividing a band frequency of the first base band signal into a plurality of second bands;
a phase circuit controlling a phase of a signal of each of the second bands in reference to the phase of the signal of the first bands;
a combining part combining an output of the phase circuit;
a modulator modulating an output of the combining part by the first modulating scheme;
an amplifier controlling an amplitude of an output of the modulator in reference to the amplitude of the signal of the first bands, wherein an output of the amplifier is the cancel signal.

8. The communications apparatus according to claim 2, wherein the cancel signal generating apparatus comprises:
a detecting circuit dividing a band frequency of the second base band signal into a plurality of first bands, and detecting a phase and an amplitude of a signal of each of the first bands;
a division part dividing a band frequency of the first base band signal into a plurality of second bands;
a phase circuit controlling a phase of a signal of each of the second bands in reference to the phase of the signal of the first bands;
a combining part combining an output of the phase circuit;
a modulator modulating an output of the combining part by the first modulating scheme;
an amplifier controlling an amplitude of an output of the modulator in reference to the amplitude of the signal of the first bands, wherein an output of the amplifier is the cancel signal.

9. The communications apparatus according to claim 1, wherein the cancel signal is combined with the receiving input signal between the antenna duplexer and the receiving circuit.

10. The communications apparatus according to claim 3, wherein the cancel signal is combined with the receiving input signal between the antenna duplexer and the receiving circuit.

11. The communications apparatus according to claim 7, wherein the cancel signal is combined with the receiving input signal between the antenna duplexer and the receiving circuit.

12. The communications apparatus according to claim 8, wherein the cancel signal is combined with the receiving input signal between the antenna duplexer and the receiving circuit.
